(19) United States
(12) Patent Application Publication
(10) Pub. No.: US 2007/0050428 A1
(43) Pub. Date: Mar. 1, 2007

(54) Method and system for version control of composite design objects

(75) Inventors: Srinath Anantharaman, Pleasanton, CA (US); Anagha Pandharpurkar, Fremont, CA (US)

Correspondence Address: William L. Botjer, PO Box 478, Center Moriches, NY, 11934, US

(73) Assignee: CLIOSOFT INC.

(21) Appl. No.: 11/212,010

(22) Filed: Aug. 25, 2005

(51) Int. Cl. G06F 17/30

(52) U.S. Cl. 707/203

(57) ABSTRACT

A method, system and computer program product for version control in design tools. The method manages the information of one or more files in the design tools. A set of files forming a composite object are arranged as a single object in the form of a package. A new version of the package may be created to include the revisions made to one or more files of the package. These revisions include modifications, the addition of or the deletion of at least one file from the package. Further, these revisions are performed on the package as a single entity.

### BACKGROUND

The present invention relates generally to information management. More specifically, it relates to a method, system and computer program product for version control of multiple files that represent a design object in circuit design software.

Circuit designing involves creation of various design objects, such as schematics, mask layouts and printed circuit boards. These design objects are used for communication, power distribution, synchronization, etc. in circuits. A design object is a collection of multiple files. This collection of multiple files is also referred to as a composite object. Various engineering and scientific design tools, such as Electronic Design Automation (EDA) tools are used to create composite objects. The composite objects may be revised from time to time by several users. Further, various files of the composite objects may be accessed by two or more users simultaneously. The revision of a composite object involves modification of one or more files, addition of one or more files, or deletion of one or more files. Therefore, the set of files forming the composite object may change with each revision. These revisions are required to be maintained in separate versions of the composite object, in order to provide consistency in accessing the multiple files.

In the present state of technology, various revision control systems are available. A revision control system tracks and provides control over different versions of a composite object. Various methods are employed for controlling versions of the composite object. In one such method, each file in a composite object is separately managed. Further, the same revision number or unique label is assigned to each file in the composite object. The multiple files forming the composite objects are thus maintained as a collection of files. A version of the composite object is then accessed by referring to the revision number or the unique label assigned to the files.

However, the existing methods require manual intervention in accessing a composite object. This may lead to inconsistency in accessing various versions of the composite object. Further, the multiple files maintained in different versions of a composite object may not be accessed efficiently.

In light of the above discussion, there is a need for a method and system for managing different versions of a composite object, which eliminates the manual selection of different revision numbers or labels of the individual files forming the composite object.

### SUMMARY

An object of the invention is to control and manage various versions of composite objects generated by design tools.

Another object of the invention is to make revision control operations on composite objects atomic.

Still another object of the invention is to make version control of composite objects more efficient than version control of multiple files.

To achieve the above objectives, the invention provides a method, system and computer program product for controlling various versions of composite objects. The multiple files forming a composite object are arranged into a package. The package is treated as a single entity on a server, and revision control operations, such as checking-in, checking-out, labeling, branching, editing, deleting are performed on the package. New versions of the package are created, based on the revisions made to the composite object. These revisions include modifications of one or more files, addition or deletion of one or more files from the composite objects.

Various packages representing different versions of a composite object are stored in a repository that is located at a server. In one embodiment of the invention, multiple files forming the composite object are placed in workareas from the repository. In other words, the component files of a package are copied to the workareas. In another embodiment of the invention, the various packages are also placed in a cache located at the same or another server. User's workareas have links to the multiple files in the cache, forming the package. A user may access a file of the composite object through these links.

The arrangement of the composite object into a package helps in efficient management of revision control operations performed on the component files of the package. Each package is managed as a single entity. This makes the version control of composite objects an atomic process. In other words, the component files of the composite object can be accessed consistently. Further, the multiple files of the composite object are not required to be managed individually at a physical level. Revisions made to the multiple files by several users are managed and maintained in different versions of packages. This avoids inconsistency in accessing various versions of the composite objects.

### BRIEF DESCRIPTION OF THE DRAWINGS

The preferred embodiments of the invention will hereinafter be described in conjunction with the appended drawings, provided to illustrate and not to limit the invention, wherein like designations denote like elements, and in which:

FIG. 1 is a block diagram depicting a network in which various embodiments of the invention can be practised.

FIG. 2 is a block diagram of a system for managing composite objects, in accordance with an embodiment of the invention;

FIG. 3 is a flowchart depicting a method for managing the composite objects, in accordance with various embodiments of the invention;

FIG. 4 is a flowchart depicting a method for creating a version of a package, in accordance with an embodiment of the invention;

FIG. 5 is a flowchart depicting a method for accessing a version of the package, in accordance with an embodiment of the invention;

FIG. 6A and 6B is a flowchart depicting a method for accessing a version of the package, in accordance with another embodiment of the invention;

FIG. 7 is a block diagram depicting a package as represented in Graphical User Interfaces (GUIs), in accordance with an embodiment of the invention; and

FIG. 8 is a block diagram depicting an example of a mask layout design object, in accordance with an embodiment of the invention.

### DESCRIPTION OF PREFERRED EMBODIMENTS

Various embodiments of the invention provide methods and systems for information management in design tools. In particular, the various embodiments pertain to version control of composite objects created by design tools. One or more files forming the composite object are managed together as a single file, hereinafter referred to as a package. The package is treated as a single entity while performing various revision control operations.

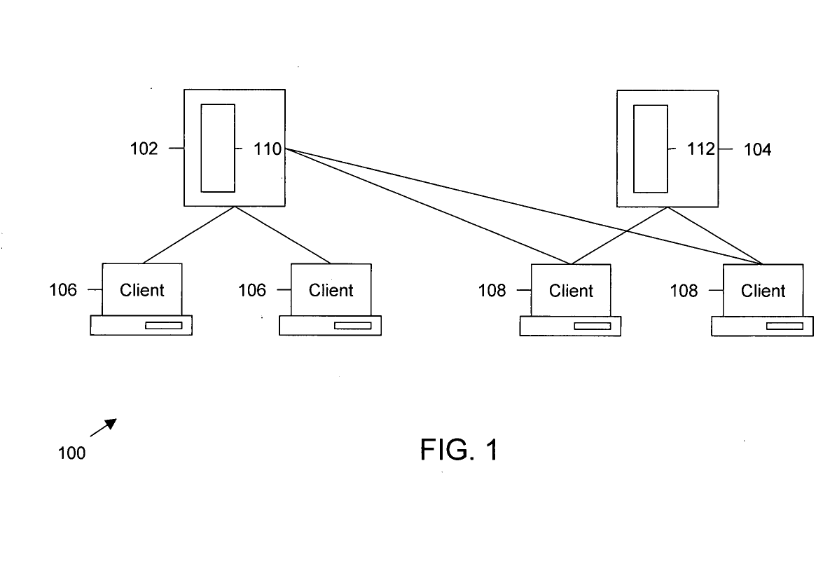

FIG. 1 is a block diagram depicting a network 100 in which various embodiments of the invention can be practised. Network 100 is a client-server network. Network 100 includes a plurality of servers, hereinafter referred to as servers 102 and 104, and a plurality of clients, hereinafter referred to as clients 106 and 108. In various embodiments of the invention, network 100 may be a Local Area Network (LAN), Wide Area Network (WAN), peer-to-peer network and the like. Clients 106 and 108 are connected to server 102. Further, clients 108 are also connected to server 104.

In one embodiment of the invention, servers 102 and 104 are connected to each other. Further, clients 108 are not connected to server 102 and access data from server 102 through server 104.

Servers 102 and 104 include a repository 110 and a cache 112, respectively. Composite objects that are created by design tools are stored in repository 110. In one embodiment of the invention, the composite objects that are being accessed by users may be placed on cache 112. The composite objects are then accessed directly from cache 112.

Clients 106 and 108 access the component files of various versions of the composite objects stored in repository 110. Clients 106 and 108 perform revision control operations, such as checking-in, checking-out, labeling, branching, editing and deleting, on the composite objects, to design and modify the composite objects. Examples of clients 106 and 108 include desktop computers, laptops, electronic simulation devices, and so forth. Clients 106 and 108 are hereinafter referred to as workareas.

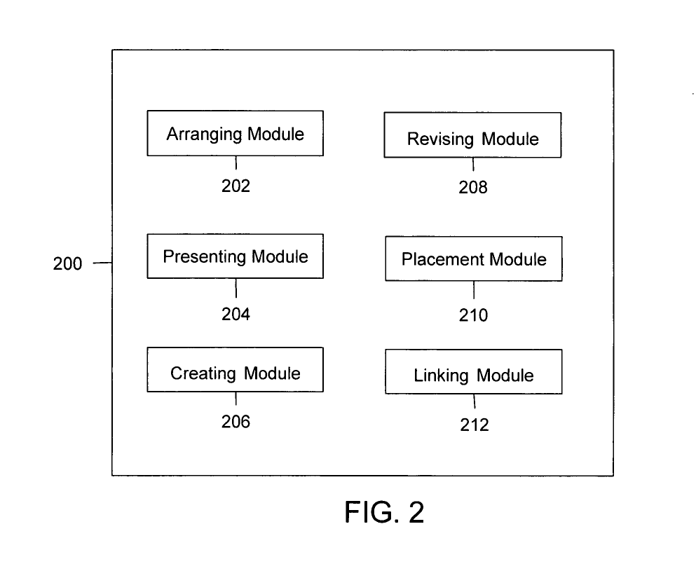

FIG. 2 is a block diagram of a system 200 for managing composite objects, in accordance with an embodiment of the invention. System 200 includes an arranging module 202, a presenting module 204, a creating module 206, a revising module 208, a placement module 210, and a linking module 212.

Arranging module 202 arranges one or more files representing a composite object, into a package. The one or more files representing a composite object arranged in the form of a package are hereinafter, referred to as component files of the package. The package is treated as a single object on servers 102 and 104. Presenting module 204 presents the package as a single object to the users, i.e., the component files of the package are not visible in a user interface though they are physically created on the workareas. The package includes at least one data file and an attribute. The at least one data file contains the data from the component files that form the package. Further, the attribute of the package contains a list of the component files and their pathnames. The package may be used by several users, to access the component files, and to make subsequent revisions.

Creating module 206 creates a further version of an existing package, based on the revisions made to component files of the package. Revisions include modifications to one or more of the component files, addition or deletion of one or more files from the package. Creating module 206 further stores the revised package as a new version of the package in the repository 110.

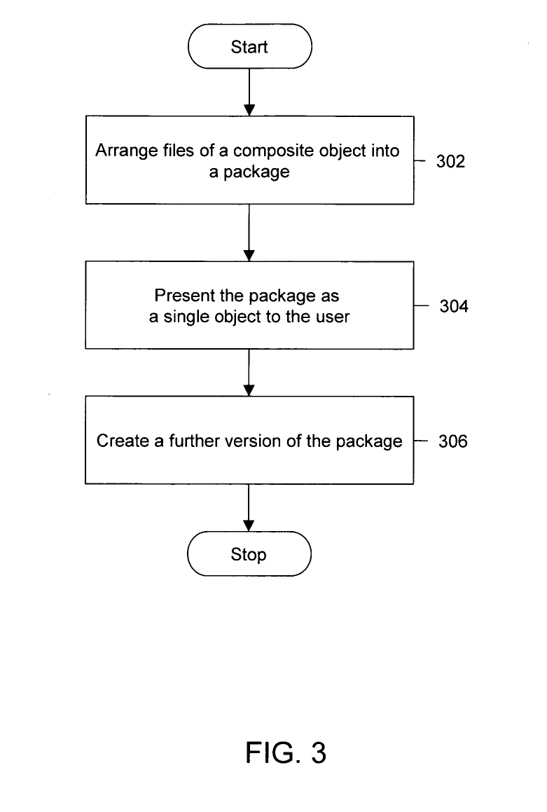

Revising module 208 performs revision control operations on different packages. These revision control operations are performed on a package, and not on individual component files. In other words, a package is treated as a single entity. The method for managing revision control operations on the package is described in detail in conjunction with FIG. 3.

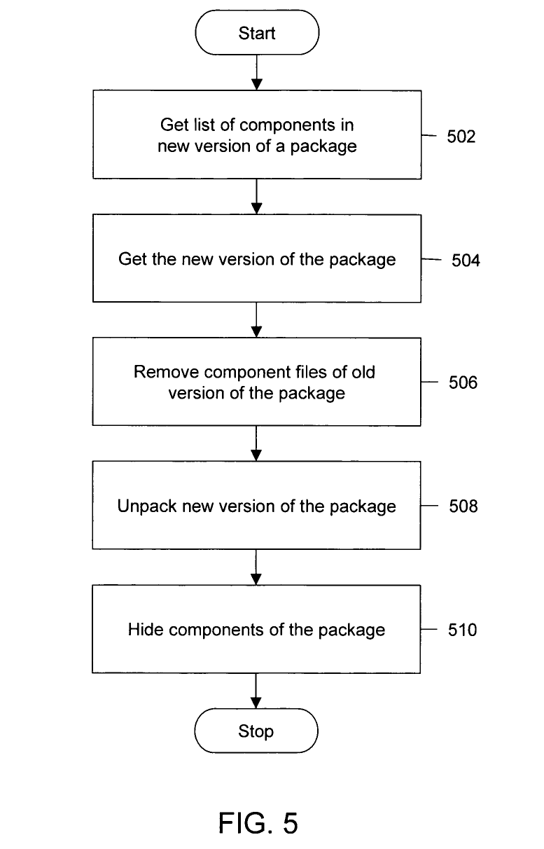

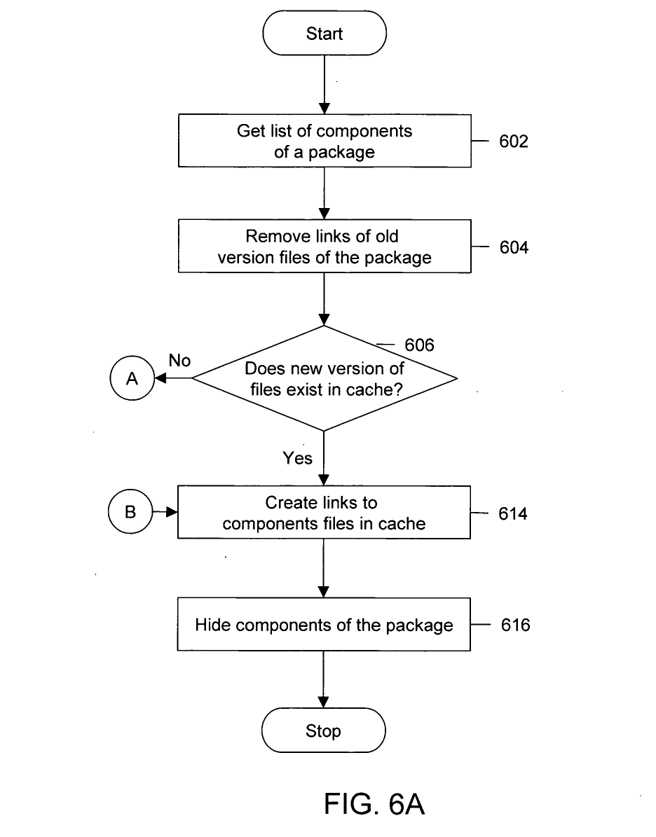

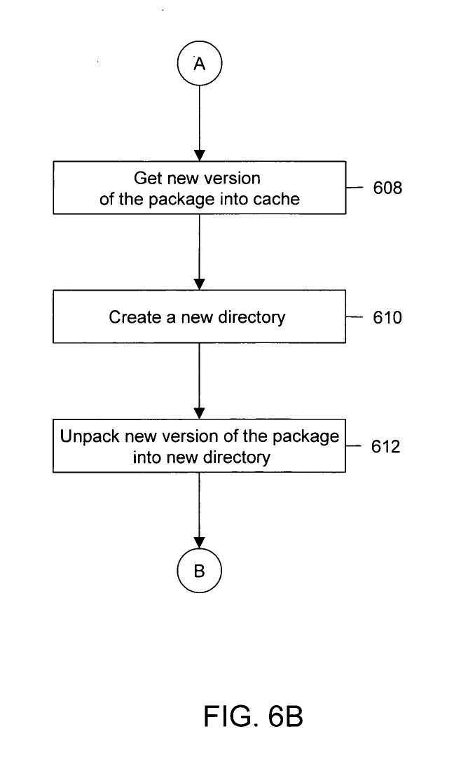

Placement module 210 places the desired version of packages in workareas 106 and 108, to enable the users to access them. Various design operations such as design changes, simulations and modifications can thus be performed by the users on the component files of the packages in the workareas 106 and 108. In one embodiment of the invention, the component files being accessed by the users on workareas 106 and 108 are simultaneously placed in cache 112. Other users may thereafter, access the component files of the package from cache 112. The method of placing and accessing the package on workareas 106 and 108, and cache 112 is described in detail in conjunction with FIG. 5, FIG. 6A and FIG. 6B

Linking module 212 creates links in the workareas 106 and 108 to component files of the package placed in cache 112. In one embodiment of the invention, linking module 212 creates links in workareas 106 and 108 to the component files of the package stored in repository 110 or cache 112.

In one embodiment of the invention, various modules of system 200 are implemented as software modules. It will be apparent to those skilled in the art that system 200 may be implemented in various document management systems FIG. 3 is a flowchart depicting a method for managing composite objects, in accordance with various embodiments of the invention. At step 302, one or more files forming a composite object are arranged in the form of a package. The data from the one or more files of the composite object is included in a data file. Further, the list of the one or more files and their pathnames are maintained as an attribute of the package. The pathnames are maintained in relation to the package. For example, for a package P1 having four component files A, B, C and D stored in a folder FA, the pathnames of the files relative to the package may be represented as:

File A

File B

Folder 1/File C

Folder 2/File D

Files A and B are maintained directly in package P1, whereas File C and D are included in folder 1 and folder 2 of package P1, respectively. The maintenance of pathnames in relation to the package facilitates the movement of the package from one parent folder to another folder. In the above example, package P1 in folder FA may be moved to another folder FB. However, this movement of package P1 does not affect the attribute of the package as the pathnames are in relation to package P1. In other words, the attribute of a package need not be changed if its location is changed.

In various embodiments of the invention, the package is treated as a single object in the server. In other words, the entire package is accessed from the server, whenever required by the user. At step 304, the package is presented as a single object to the users. Thereafter, at step 306, a further version of the package is created in a repository, based on revisions made to one or more component files of the package. These revisions are made by the users in the workareas. The further version of the package is stored in addition to the existing versions of the package in the repository. The further version of the package is also referred to as a new version.

In accordance with various embodiments of the invention, revision control operations such as checking-in, checking-out, labeling, branching, deleting, moving and editing are atomically performed on the packages and not on individual component files. In other words, when a user accesses a package from the repository to make revisions, the entire package is checked-out from the repository. The package is marked as locked after being checked-out by the user. This does not allow other users to make revisions to any of the component files. After the revisions are made to the component files, the package is checked-in to the repository. The revised package is stored as a new version of the package. The lock is then removed from the earlier version of the package that was checked-out.

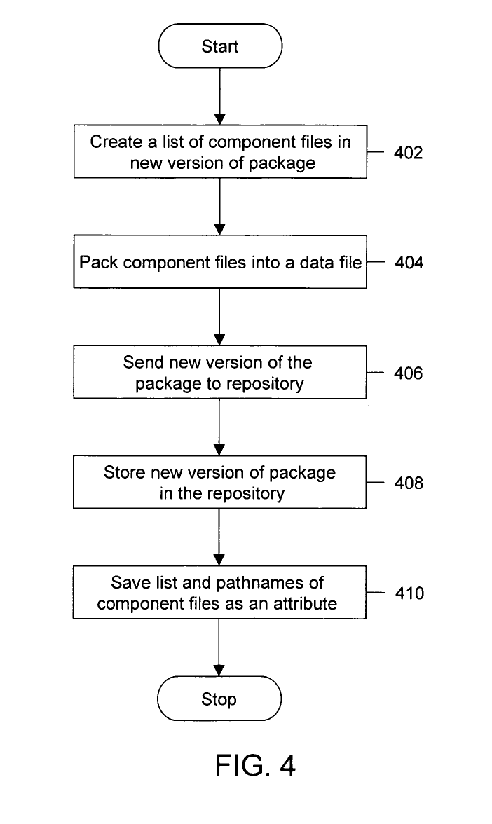

FIG. 4 is a flowchart depicting a method for creating a new version of a package, in accordance with an embodiment of the invention. At step 402, a list of component files of a package is created after revisions have been made to the component files. The list can be accessed by the user through the user interface. At step 404, the data from the component files of the package are packed in the form of a single file. At step 406, a new version of the package is sent to the repository. Thereafter, at step 408, the new version of the package is stored in the repository to contain the revised component files of the package. At step 410, the list of component files is stored in the form of an attribute of the new version of the package. The attribute of the package contains pathnames of the component files of the composite object. Further, the pathnames of the files are maintained relative to the package.

FIG. 5 is a flowchart depicting a method for accessing a version of a package, from the repository, in accordance with an embodiment of the invention. At step 502, a list of pathnames of component files of a new version of the package is placed in a workarea, i.e., the attribute of the package is copied to the workarea. In one embodiment of the invention, a user may access an old version of the package from the repository. At step 504, the package is placed in the workarea. In other words, the data file containing information from all the component files of the new version of the package is copied to the workarea. At step 506, the component files of the old version of the package present in the workarea, are removed. This ensures that the files from the older version of the package are not left behind in the workarea.

Thereafter, at step 508, the new version of the package is unpacked in the workarea. In other words, the component files of the new version of the composite object are made accessible to the user. At step 510, the component files of the new version of the package are hidden so that they are not visible in a user interface. This enables the users to view the composite object in the form of a package, rather than individual component files.

FIG. 6A and FIG. 6B is a flowchart depicting a method for accessing a version of a package from a cache, in accordance with another embodiment of the invention. The component files of a package are placed in the cache, while being accessed by the workareas. In one embodiment of the invention, wherein servers 102 and 104 are connected to each other, the component files of a package are placed directly on the cache from the repository. At step 602, a list of pathnames of component files of a package is copied to the workarea from the cache. At step 604, the links of the component files of the old version of the package, to the cache, are removed. At step 606, the existence of the new version of the files of the package in the cache is checked. If the new version of the package does not exist in the cache, at step 608, the new version of the package is copied to the cache from the repository. At step 610, a directory of component files of the package is created in the cache to maintain the contents of the package. Thereafter, at step 612, the new version of the package is unpacked into the directory.

If the new version of the package exists in the cache or a new version of the package is unpacked at step 612, at step 614, links are created in the workarea to the component files of the package in the cache. The component files of the package are then accessed with the help of the links to the cache. Thereafter, at step 616, the component files of the composite object contained within the package are hidden from the user, i.e., the component files of the package are not visible to the user in the user interface. Component files can be accessed via links to the cache without physically copying them into the workarea.

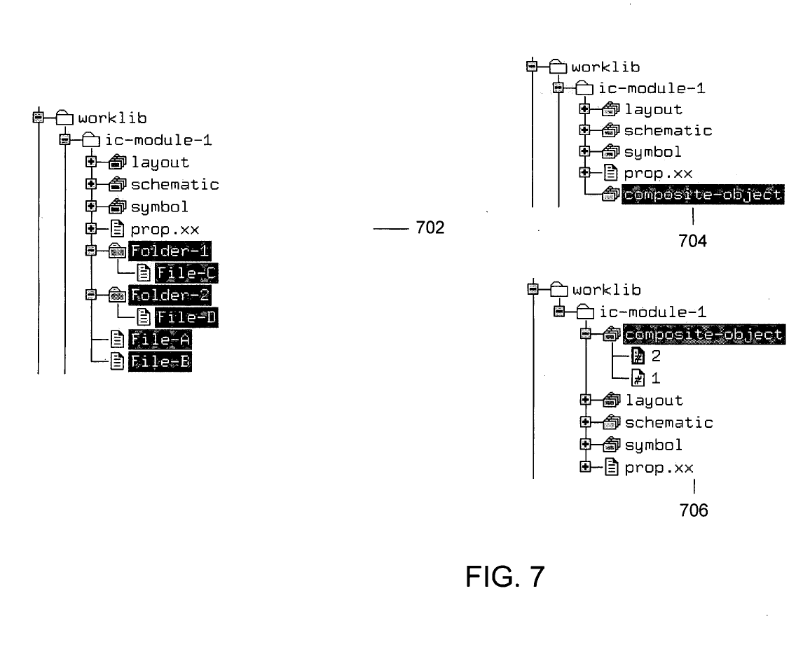

The method for creating a package has been illustrated with the help of FIG. 7. FIG. 7 is a block diagram depicting a package as represented in Graphical User Interfaces (GUIs), in accordance with an embodiment of the invention. GUI 702 represents the various files forming a composite object. GUI 704 represents the composite object after it has been packed into a package. Further, GUI 706 represents two versions, i.e., version one and version two of the composite object. Version one of the package contains File A, File B, Folder-1/File C and Folder-2/File D. Version two of the package contains File A, File B and Folder-3/File F. GUI 704 and 706 display the composite object as a single package instead of the component files.

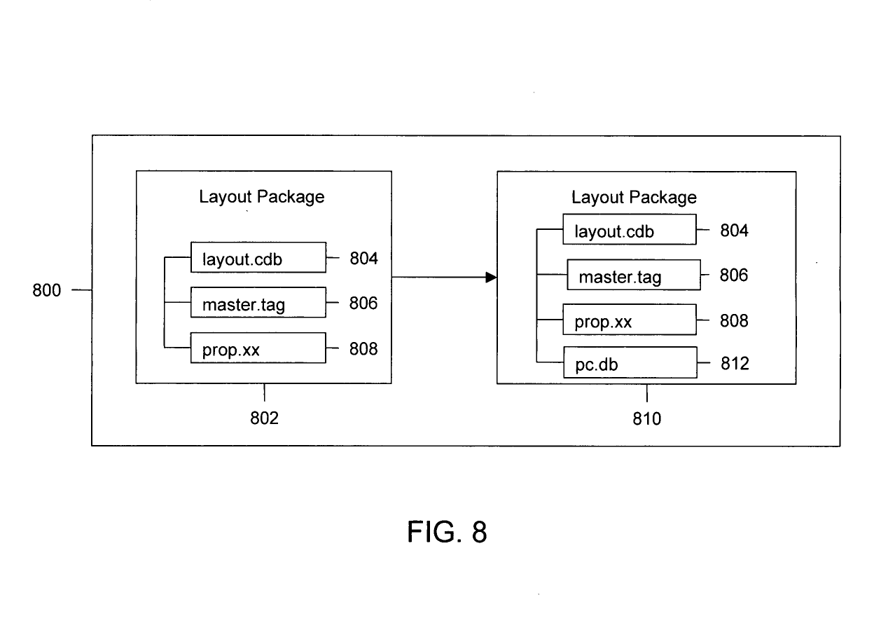

The method for creating a new version of a package as described in conjunction with FIG. 3 and FIG. 4 has been illustrated with the help of an example of a composite object that represents a mask layout of a module of an integrated circuit, in accordance with FIG. 8.

FIG. 8 is a block diagram depicting an example of a mask layout design object 800, in accordance with an embodiment of the invention. A layout package 802 represents a composite object for a mask layout of an integrated circuit. Layout package 802 is composed of various design layout files, such as Layout.cdb 804, master tag 806 and prop.xx 808. Layout package 802 is checked-out from the repository by a user to make revisions to the component files of layout package 802. For example, the user adds a file, pc.db 812, to layout package 802. This results in a new version of layout package, layout package 810. Thereafter, the user manually checks-in layout package 810 in the repository. Layout package 810 contains revised design layout files, Layout.cdb 804, master tag 806, prop.xx 808 and a new file pc.db 812. Thereafter, any of layout packages 802 and 810 may be accessed by other users. The other users may perform revisions on layout packages 802 and 810 to create further versions of the packages.

The method and system described above has a number of advantages. The one or more files forming a composite object are represented as a package. Hence, the users can effectively manage the one or more files and can work at a logical abstraction level. Revision control operations are performed on the packages, thereby providing atomicity in accessing the component files of the composite objects. Managing the composite object as a single package instead of multiple separate files improves efficiency for revision control operations. The attribute of the package contains the pathnames of the component files in relation to the package and not the absolute pathname of the files. Therefore, the package can be easily moved from one location in the workarea to another. This provides efficient management and organization of the one or more files forming composite objects.

Further, revisions made to the files by several users are managed and maintained in different versions of the packages, thereby avoiding inconsistency in versions of the composite objects. The component files may also be stored in a cache. The component files in multiple workareas may be created as links to the component files in the cache. Hence, the package need not be copied to the workareas.

The system for managing the information of multiple files representing a composite object in design tools, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps constituting the method of the present invention.

The computer system comprises a computer, an input device, a display unit and the Internet. The computer further comprises a microprocessor. The microprocessor is connected to a communication bus. The computer also includes a memory. The memory may include Random Access Memory (RAM) and Read Only Memory (ROM). The computer system further comprises a storage device. The storage device can be a hard disk drive or a removable storage drive such as a floppy disk drive, optical disk drive, etc. The storage device can also be other similar means for loading computer programs or other instructions into the computer system. The computer system also includes a communication unit. The communication unit allows the computer to connect to other databases and the Internet through an I/O interface. The communication unit allows the transfer as well as reception of data from other databases. The communication unit may include a modem, an Ethernet card, or any similar device which enables the computer system to connect to databases and networks such as LAN, MAN, WAN and the Internet. The computer system facilitates inputs from a user through input device, accessible to the system through I/O interface.

The computer system executes a set of instructions that are stored in one or more storage elements, in order to process input data. The storage elements may also hold data or other information as desired. The storage element may be in the form of an information source or a physical memory element present in the processing machine.

The set of instructions may include various commands that instruct the processing machine to perform specific tasks such as steps that constitute the method of the present invention. The set of instructions may be in the form of a software program. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A method for managing information of one or more files located on one or more servers, the one or more files representing a composite object, the method comprising the steps of:
a. arranging the one or more files into a package;
b. presenting the package as a single object to a user; and
c. creating a further version of the package based on revisions made to the one or more files.

2. The method according to claim 1, wherein the package comprises at least one data file, wherein the at least one data file contains data from the one or more files arranged in the package.

3. The method according to claim 1, wherein the package comprises at least one attribute, wherein the at least one attribute contains paths for the one or more files, the paths being relative to the package.

4. The method according to claim 1 further comprising the step of performing revision control operations on the package.

5. The method according to claim 4, wherein the revision control operations comprises one or more of checking-in, checking-out, branching, labeling, getting version history, deleting, moving, renaming and editing.

6. The method according to claim 1, wherein the revisions made to the one or more files comprises one or more of addition of at least one file to the package, deletion of at least one file from the package, and modification of at least one file of the package.

7. The method according to claim 1, wherein the package and versions of the package are stored in a repository located on the server.

8. The method according to claim 1 further comprising the step of placing the package on a plurality of workareas.

9. The method according to claim 1 further comprising the step of placing the package in a cache, wherein the cache is located on a server.

10. The method according to claim 9 comprising the step of providing links of the one or more files on the cache to a plurality of workareas.

11. The method according to claim 1 wherein the one or more files comprise design objects.

12. A system for managing information of one or more files located on one or more servers, the one or more files representing a composite object, the system comprising:
a. an arranging module for arranging the plurality of files into a package;
b. a presenting module for presenting the package as a single object to a user and
c. a creating module for creating a further version of the package based on revisions made to the one or more files.

13. The system according to claim 12 further comprising a revising module for performing revision control operations on the package.

14. The system according to claim 13, wherein the revision control operations comprises one or more of checking-in, checking-out, branching, labeling, getting version history, deleting, moving, renaming and editing.

15. The system according to claim 12 further comprising a placement module for placing the one or more files of the package on a plurality of workareas.

16. The system according to claim 12 further comprising a placement module for placing the one or more files of the package in a cache, wherein the cache is located on a server.

17. The method according to claim 16 comprising a linking module for providing links of the one or more files on the cache to a plurality of workareas.

18. The system according to claim 12, wherein the package and versions of the package are stored in a repository located on the server.

19. The system according to claim 12, wherein the one or more of files are represented as the package on a server.

20. A computer program product for use with a computer, the computer program product comprising a computer usable medium having a computer readable program code embodied therein for managing information of one or more files located on one or more servers, the one or more files representing a composite object, the computer readable program code performing the steps of:
a. arranging the one or more files into a package;
b. presenting the package as a single object to a user and
c. creating a further version of the package based on revisions made to the one or more files.

21. The computer program product according to claim 20, wherein the computer readable program code further performing the step of performing revision control operations on the package.

22. The computer program product according to claim 20 wherein the one or more files comprise design objects.
